(19) United States
(12) Patent Application Publication
(10) Pub. No.: US 2024/0269701 A1
(43) Pub. Date: Aug. 15, 2024

(54) MISTING SYSTEM AND CONTROL METHOD

(71) Applicant: Panasonic Intellectual Property Management Co., Ltd., Osaka (JP)

(72) Inventors: Takeshi OGATA, Osaka (JP); Kota KIMURA, Saitama (JP)

(73) Assignee: Panasonic Intellectual Property Management Co., Ltd., Osaka (JP)

(21) Appl. No.: 18/564,072

(22) PCT Filed: Aug. 26, 2022
(86) PCT No.: PCT/JP2022/032211

§ 371 Date: Nov. 25, 2023

(30) Foreign Application Priority Data
Oct. 15, 2021 (JP) 2021-169711

(51) Int. Cl. B05B 12/12; B05B 14/00

(52) U.S. Cl. CPC B05B 12/12; B05B 14/00

(57) ABSTRACT

A misting system includes: a misting device that sprays mist in a space; and a control device that controls a temperature of a floor of the space. The control device controls the temperature of the floor to cause the temperature of the floor to be greater than or equal to a temperature Tn that satisfies Equation 1 below, where an amount of the mist sprayed in the space by the misting device is denoted by M, an amount of water vapor in the space is denoted by N, and a temperature calculated based on a temperature of the space is denoted by Tn.

$$\begin{matrix}[ Math . 1 ] & \\ M + N = \frac{217 \times 6.1078 \times {10}^{\frac{7.5 \times Tn}{Tn + 237.3}}}{Tn + 273.15} & ( Equation 1 )\end{matrix}$$

### TECHNICAL FIELD

The present disclosure relates to a misting system and a control method for spraying mist in a space.

### BACKGROUND ART

There are cases in which a performance is held where a mist of atomized liquid is sprayed in a space, such as an event hall (indoor space), for example, and light is emitted toward a spraying range of the mist (see Patent Literature (PTL) 1, for example).

### CITATION LIST

### Patent Literature

[PTL 1] Japanese Unexamined Patent Application Publication No. 2015-179130

### SUMMARY OF INVENTION

### Technical Problem

The present disclosure provides a misting system and a control method that can prevent a floor of a space from becoming wet due to mist sprayed in the space.

### Solution to Problem

A misting system according to the present disclosure includes: a misting device that sprays mist in a space; and a control device that controls a temperature of a floor of the space. The control device controls the temperature of the floor to cause the temperature of the floor to be greater than or equal to a temperature Tn that satisfies Equation 1 below, where an amount of the mist sprayed in the space by the misting device is denoted by M, an amount of water vapor in the space is denoted by N, and a temperature calculated based on a temperature of the space is denoted by Tn.

$$\begin{matrix}[ Math . 1 ] & \\ M + N = \frac{217 \times 6.1078 \times {10}^{\frac{7.5 \times Tn}{Tn + 237.3}}}{Tn + 273.15} & ( Equation 1 )\end{matrix}$$

### Advantageous Effects of Invention

The misting system, and the like, according to the present disclosure can prevent a floor of a space from becoming wet due to mist sprayed in the space.

### BRIEF DESCRIPTION OF DRAWINGS

FIG. 1 is a diagram illustrating an outline of a misting system according to an embodiment.

FIG. 2 is a block diagram illustrating a functional configuration of a control device according to the embodiment.

FIG. 3 is a flowchart illustrating the flow of operation of the misting system according to the embodiment.

FIG. 4 is a graph illustrating examples of calculation of temperature Tn by the control device according to the embodiment.

FIG. 5 is a diagram for describing a correlation between the degree of hydrophilicity of a floor and the size of the contact area of a mist droplet with the floor.

FIG. 6 is a diagram for describing a discomfort index.

### DESCRIPTION OF EMBODIMENTS

### Underlying Knowledge Forming Basis of the Present Disclosure

In relation to the technique described in the “Background Art” section, the inventors have found the following problems.

When mist is continually sprayed in a space, such as an event hall, or the like, that is not frequently ventilated, the mist falls on a floor of the space before the mist is able to fully evaporate, and thus, there is a risk that the floor of the space may become wet due to the mist. As a result, problems arise, such as where the floor becomes dirty due to dust, sand, or the like, sticking to the floor that has become wet due to the mist, or where the floor becomes difficult for people to walk on.

In view of this, the inventors have, as a result of their repeated, diligent investigation, conceived of a misting system and a control method that can prevent a floor of a space from becoming wet due to mist sprayed in the space.

Hereinafter, embodiments will be described in detail with reference to the figures as needed. However, there are instances where excessively detailed descriptions may be omitted. For example, detailed descriptions of well-known matters or repeated descriptions of elements that are essentially the same may be omitted. This is to make the following descriptions easier to understand for those skilled in the art and to avoid redundancy.

Note that the inventors provide the accompanying figures and the following descriptions not to limit the scope of the claims, but to aid those skilled in the art to adequately understand the present disclosure.

### Embodiment

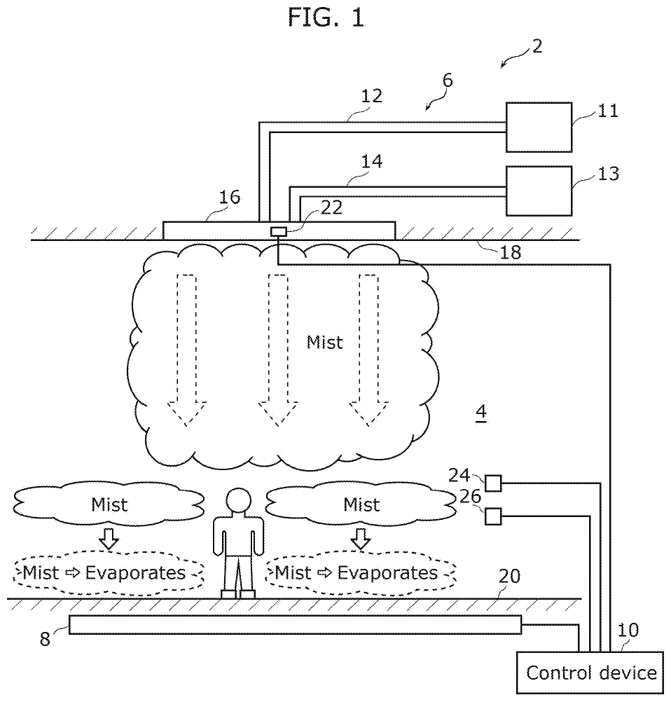

Hereinafter, an embodiment will be described with reference to FIG. 1 to FIG. 6.

### [1. Outline of Misting System]

First, an outline of misting system 2 according to this embodiment will be described with reference to FIG. 1. FIG. 1 is a diagram illustrating an outline of misting system 2 according to this embodiment.

As illustrated in FIG. 1, misting system 2 is a system that sprays mist in space 4 for a performance in space 4, that is, for example, an event hall or the like. Space 4 is an indoor space surrounded by ceiling 18 located above, floor 20 located below, and walls located on the sides (not illustrated in the figure). It should be noted that floor 20 of space 4 is made of a material with relatively high hydrophilicity, such as plywood, natural wood, synthetic resin with a textured surface, or concrete, for example.

Misting system 2 includes misting device 6, floor heating device 8, and control device 10. It should be noted that to enhance the effects of the performance in space 4, light may be emitted from a lighting device (not illustrated in the figure) toward a spraying range of the mist while the mist is being sprayed in space 4.

Misting device 6 is a device for spraying mist in space 4, and is a twin-fluid nozzle-type misting device that atomizes a liquid with gas, such as nitrogen or air, for example. Misting device 6 includes compressed air supply 11 that supplies compressed air, compressed air channel 12, liquid supply 13 that supplies water (liquid), liquid channel 14, and nozzle 16. Compressed air from compressed air supply 11 is supplied to nozzle 16 via compressed air channel 12, and water from liquid supply 13 is supplied to nozzle 16 via liquid channel 14.

Nozzle 16 is provided in ceiling 18 of space 4. A first channel (not illustrated in the figure) communicating with compressed air channel 12 and a second channel (not illustrated in the figure) communicating with liquid channel 14 are provided inside of nozzle 16. Inside of nozzle 16, compressed air that flows in the first channel and water that flows in the second channel are mixed together, and the water is reduced to fine particles by the compressed air, thereby atomizing the water and generating mist. Mist generated inside of nozzle 16 is sprayed downward from nozzle 16 toward space 4. It should be noted that the particle diameter of the mist (mist droplets) sprayed in space 4 by misting device 6 is preferably at least 3 μm and at most 10 μm. In the present embodiment, while nozzle 16 is provided in ceiling 18 of space 4, nozzle 16 is not limited to this, and may, for example, be provided in a wall of space 4 (not illustrated in the figure), floor 20, or the like, and may be provided at any position, as long as mist can be sprayed in space 4 in accordance with the performance in space 4.

Note that in the present embodiment, although water is sprayed from misting device 6, misting device 6 is not limited to this, and may, for example, spray an arbitrary liquid, such as a sanitizing liquid or a liquid disinfectant, or may spray a mixture of water and a liquid other than water.

Furthermore, instead of the previously mentioned twin-fluid nozzle-type configuration, misting device 6 may be configured to generate mist by atomization of water (liquid) stored in a tank, for example, caused by the vibrations of an ultrasonic oscillator.

Floor heating device 8 is a device for heating floor 20 of space 4, and is provided below floor 20 of space 4. Floor heating device 8 may, for example, be any known heating device, such as a hot water circulating-type floor heating device or the like. It should be noted that floor 20 of space 4 may be heated by laying down a heating appliance, such as an electric carpet, for example, on floor 20 of space 4 in place of floor heating device 8.

Control device 10 is a controller for controlling the temperature of floor 20 of space 4. Specifically, control device 10 calculates the temperature Tn that satisfies Equation 1, which will be described later, based on respective detection signals from mist amount sensor 22, temperature sensor 24, and humidity sensor 26, and controls floor heating device 8 to cause temperature Tf of floor 20 of space 4 to be greater than or equal to the temperature Tn calculated.

Here, mist amount sensor 22 is a sensor for detecting the amount (g/m³) of mist sprayed in space 4 from nozzle 16, and is provided in nozzle 16. Note that although mist amount sensor 22 is provided in nozzle 16 in this embodiment, mist amount sensor 22 is not limited to this, and may be provided, for example, at a location on misting device 6 other than in nozzle 16 (for example, liquid channel 14 or the like), or may measure the liquid flow rate of misting system 2. Furthermore, temperature sensor 24 is a sensor for detecting the temperature (° C.) of space 4, and is provided in space 4. Furthermore, humidity sensor 26 is a sensor for detecting the humidity (%/y) of space 4, and is provided in space 4.

### 2. Functional Configuration of Control Device

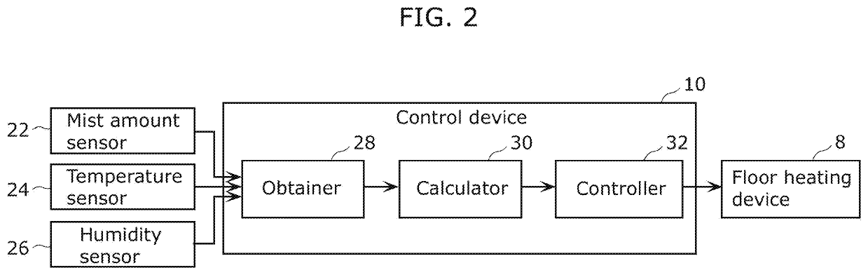

Next, a functional configuration of control device 10 will be described with reference to FIG. 2. FIG. 2 is a block diagram illustrating a functional configuration of control device 10 according to this embodiment.

As illustrated in FIG. 2, control device 10 includes obtainer 28, calculator 30, and controller 32, as functional components.

Obtainer 28 obtains the amount of mist detected by mist amount sensor 22, the temperature detected by temperature sensor 24, and the humidity detected by humidity sensor 26. Obtainer 28 outputs the detected amount of mist, the detected temperature, and the detected humidity obtained to calculator 30.

Calculator 30 calculates the temperature Tn that satisfies Equation 1 below, based on the detected amount of mist, the detected temperature, and the detected humidity from obtainer 28. Specifically, calculator 30 first calculates the amount of water vapor (g/m³) in space 4 based on the detected temperature and the detected humidity from obtainer 28. Where the detected amount of mist is denoted by M, the amount of water vapor in space 4 is denoted by N, and a temperature calculated based on the temperature of space 4 is denoted by Tn, calculator 30 calculates the temperature Tn that satisfies Equation 1 below. It should be noted that the right side of Equation 1 below represents the amount of saturated water vapor (g/m³) at temperature Tn. In other words, the temperature Tn that satisfies Equation 1 below is a temperature of space 4 at which the sum of the detected amount of mist M and the amount of water vapor N in space 4 becomes equal to the amount of saturated water vapor. Calculator 30 outputs a calculation result to controller 32.

$$\begin{matrix}[ Math . 1 ] & \\ M + N = \frac{217 \times 6.1078 \times {10}^{\frac{7.5 \times Tn}{Tn + 237.3}}}{Tn + 273.15} & ( Equation 1 )\end{matrix}$$

Controller 32 controls temperature Tf of floor 20 of space 4 by controlling floor heating device 8 to cause temperature Tf of floor 20 to be greater than or equal to the temperature Tn that satisfies Equation 1 above, based on the calculation result of calculator 30.

### 3. Operation of Misting System

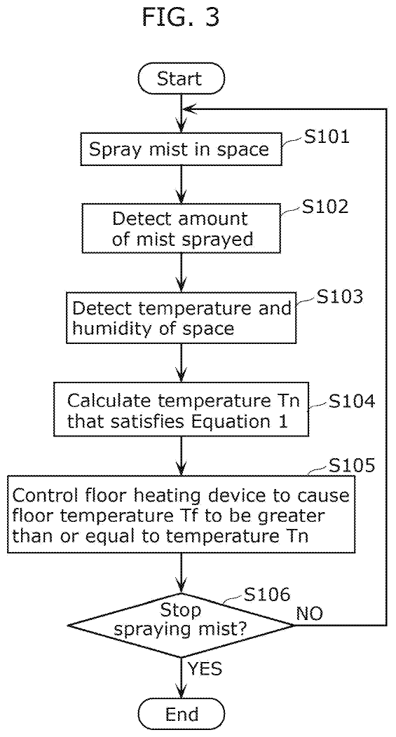

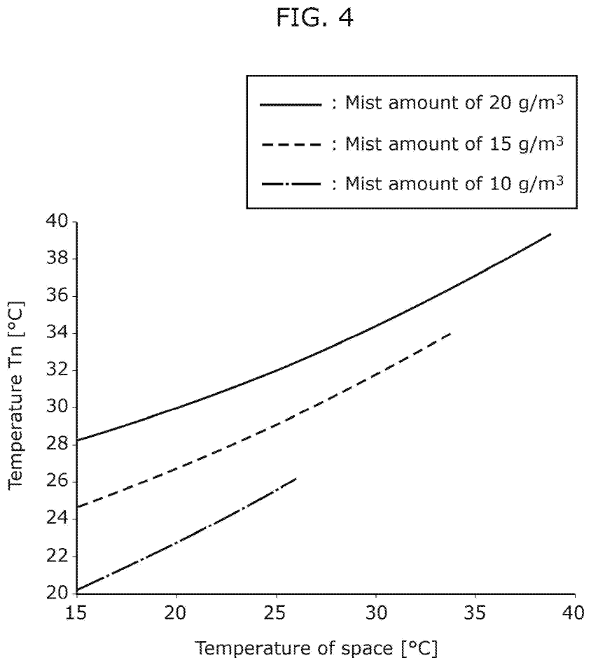

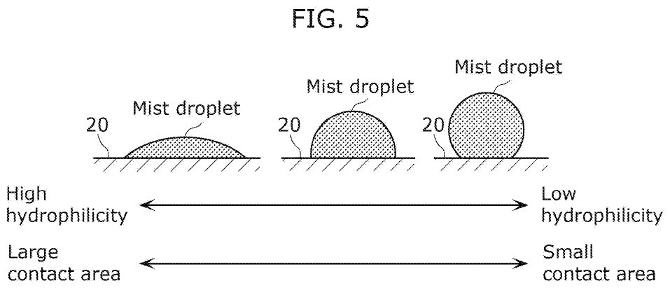

Next, the operation of misting system 2 according to this embodiment will be described with reference to FIG. 1 and FIG. 3 to FIG. 5. FIG. 3 is a flowchart illustrating the flow of operation of misting system 2 according to this embodiment. FIG. 4 is a graph illustrating examples of calculation of temperature Tn by control device 10 according to this embodiment. FIG. 5 is a diagram for describing a correlation between the degree of hydrophilicity of floor 20 and the size of the contact area of a mist droplet with floor 20.

As illustrated in FIG. 3, misting device 6 first sprays mist in space 4 (S101). As illustrated in FIG. 1, the mist sprayed by misting device 6 flows down toward floor 20 of space 4.

Mist amount sensor 22 detects the amount of mist sprayed in space 4 (S102), and outputs the detected amount of mist M to obtainer 28 of control device 10. Furthermore, temperature sensor 24 detects the temperature of space 4 (S103), and outputs the detected temperature T to obtainer 28 of control device 10. Furthermore, humidity sensor 26 detects the humidity of space 4 (S103), and outputs the detected humidity H to obtainer 28 of control device 10. Obtainer 28 of control device 10 outputs the detected amount of mist M, the detected temperature T, and the detected humidity H that have been obtained to calculator 30 of control device 10.

Calculator 30 of control device 10 calculates the temperature Tn that satisfies Equation 1 above, based on the detected amount of mist M, the detected temperature T, and the detected humidity H output from obtainer 28 (S104). Calculator 30 outputs a calculation result to controller 32 of control device 10.

Controller 32 of control device 10 controls floor heating device 8 to cause temperature Tf of floor 20 to be greater than or equal to the temperature Tn that satisfies Equation 1 above, based on the calculation result of calculator 30 (S105).

Here, examples of calculation of temperature Tn by calculator 30 will be described. When the detected temperature T=20° C., the detected amount of mist M=10 g/m³, and the amount of water vapor N in space 4=10.38444 g/m³, calculator 30 calculates a temperature of 22.82948° C. as the temperature Tn that satisfies Equation 1 above. In this case, controller 32 controls floor heating device 8 to cause temperature Tf of floor 20 to be greater than or equal to temperature Tn=22.82948 (≈22.8)° C.

Furthermore, when the detected temperature T=25° C., the detected amount of mist M=15 g/m³, and the amount of water vapor N in space 4=13.83220 g/m³, calculator 30 calculates a temperature of 29.04252° C. as the temperature Tn that satisfies Equation 1 above. In this case, controller 32 controls floor heating device 8 to cause temperature Tf of floor 20 to be greater than or equal to temperature Tn=29.04252 (≈29.0) ° C.

Furthermore, when the detected temperature T=30° C., the detected amount of mist M=20 g/m³, and the amount of water vapor N in space 4=18.22171 g/m³, calculator 30 calculates a temperature of 34.32497° C. as the temperature Tn that satisfies Equation 1 above. In this case, controller 32 controls floor heating device 8 to cause temperature Tf of floor 20 to be greater than or equal to temperature Tn=34.32497 (≈34.3)° C.

It should be noted that the relationship between the temperature of space 4 (the detected temperature T) and the temperature Tn that satisfies Equation 1 above is as illustrated by the graph in FIG. 4. As illustrated in FIG. 4, in each case where the detected amount of mist M=10 g/m³, 15 g/m³, or 20 g/m³, temperature Tn increases in proportion to the temperature of space 4.

The temperature of air in the vicinity of floor 20 of space 4 becomes approximately equal to temperature Tf of floor 20 due to the heat from floor heating device 8. Here, by setting temperature Tf of floor 20 to be a temperature greater than or equal to the temperature Tn that satisfies Equation 1 above, the sum of the detected amount of mist M and the amount of water vapor N in space 4 thus becomes less than or equal to the amount of saturated water vapor, thereby causing mist (liquid) present in the vicinity of floor 20 to evaporate and become water vapor (gas) present in the air in the vicinity of floor 20, as illustrated in FIG. 1. Note that in a case where temperature Tf of floor 20 is less than the temperature Tn that satisfies Equation 1 above, since the sum of the detected amount of mist M and the amount of water vapor N in space 4 will exceed the amount of saturated water vapor, mist present in the vicinity of floor 20 will not be able to evaporate and will remain in liquid form. Accordingly, by setting temperature Tf of floor 20 to be a temperature greater than or equal to the temperature Tn that satisfies Equation 1 above, mist sprayed in space 4 can be prevented from falling on and depositing on floor 20, and floor 20 can thus be prevented from becoming wet due to mist.

Returning to the flowchart in FIG. 3, after step S105, when the spraying of mist in space 4 is to be continued (“NO” in S106), the process returns to step S101. On the other hand, in a case where the spraying of mist in space 4 is to be ended (“YES” in S106), the flowchart in FIG. 3 will come to an end.

As described above, it should be noted that the particle diameter of the mist sprayed in space 4 by misting device 6 is preferably at least 3 μm and at most 10 μm. Accordingly, even in a case where the mist sprayed in space 4 does not fully evaporate and deposits on floor 20, the size of the per unit mass contact area between the mist and floor 20 can be increased. As a result, the per unit time amount of heat transferred from floor 20 to the mist deposited on floor 20 can be increased, thus causing the mist deposited on floor 20 to evaporate more quickly.

Furthermore, as illustrated in FIG. 5, the higher the degree of hydrophilicity of floor 20 is, the larger the size of the contact area between the mist (mist droplet) deposited on floor 20 and floor 20. As described above, by forming a floor 20 of space 4 made of a material with relatively high hydrophilicity, such as plywood, natural wood, synthetic resin with a textured surface, or concrete, for example, even if the mist sprayed in space 4 does not fully evaporate and deposits on floor 20, the size of the contact area between the mist and floor 20 can be increased. As a result, the per unit time amount of heat transferred from floor 20 to the mist deposited on floor 20 can be increased, thus causing the mist deposited on floor 20 to evaporate more quickly.

### 4. Advantageous Effects

In the present embodiment, misting system 2 includes misting device 6 that sprays mist in space 4 and control device 10 that controls the temperature of floor 20 of space 4. Where the amount of mist of the mist sprayed in space 4 by misting device 6 is M, the amount of water vapor in space 4 is N, and the temperature of space 4 is Tn, control device 10 controls the temperature of floor 20 to cause temperature Tf of floor 20 to be greater than or equal to the temperature Tn that satisfies Equation 1 above.

Accordingly, the temperature of air in the vicinity of floor 20 of space 4 becomes approximately equal to temperature Tf of floor 20 due to the heat from floor 20. Here, by setting temperature Tf of floor 20 to be a temperature greater than or equal to the temperature Tn that satisfies Equation 1 above, the mist present in the vicinity of floor 20 evaporates and becomes water vapor present in the air in the vicinity of floor 20. Accordingly, the mist sprayed in space 4 can be prevented from failing on and depositing on floor 20, and floor 20 can thus be prevented from becoming wet due to mist.

Furthermore, in the present embodiment, the particle diameter of the mist sprayed in space 4 by misting device 6 is at most 10 μm.

Accordingly, even if the mist sprayed in space 4 does not fully evaporate and deposits on floor 20, the mist deposited on floor 20 can be made to evaporate more quickly.

Furthermore, in the present embodiment, floor 20 is made of plywood, natural wood, synthetic resin, or concrete.

Accordingly, even in a case where the mist sprayed in space 4 does not fully evaporate and deposits on floor 20, the mist deposited on floor 20 can be made to evaporate more quickly.

Furthermore, in the present embodiment, the control method for use in misting system 2 for spraying mist in space 4 includes (a) spraying the mist in space 4 and (b) controlling the temperature of floor 20 of space 4. In the above-mentioned (b), where the amount of mist sprayed in space 4 in the above-mentioned (a) is M, the amount of water vapor in space 4 is N, and the temperature of space 4 is Tn, the temperature of floor 20 is controlled to cause the temperature of floor 20 to be greater than or equal to the temperature Tn that satisfies Equation 1 above.

Accordingly, in the same manner as described above, the mist sprayed in space 4 can be prevented from falling on and depositing on floor 20, and floor 20 can thus be prevented from becoming wet due to mist.

### 5. Variations

In the present embodiment, although controller 32 of control device 10 controls floor heating device 8 to cause temperature Tf of floor 20 to be greater than or equal to the temperature Tn that satisfies Equation 1 above, control may be performed as described below, for example. More specifically, controller 32 may control floor heating device 8 to cause temperature Tf of floor 20 to be greater than or equal to the temperature Tn that satisfies Equation 1 above, and cause a discomfort index to be less than or equal to 80.

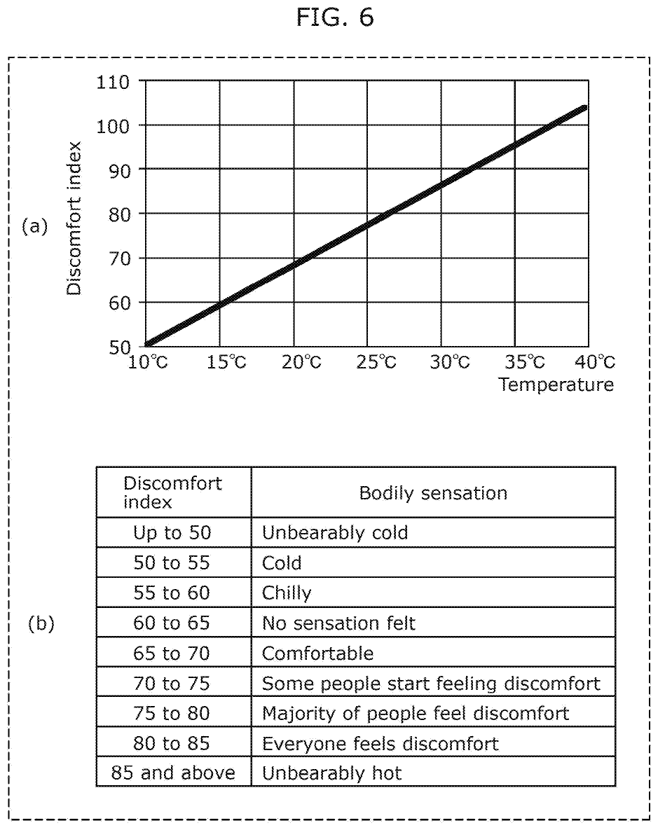

FIG. 6 is a diagram for describing the discomfort index. The discomfort index is an index of discomfort as felt by people, and is calculated based on the temperature and the humidity of space 4. As illustrated in (a) in FIG. 6, it is known that there is a proportional relationship between the temperature and the discomfort index. Furthermore, as illustrated in (b) in FIG. 6, it is known that once discomfort index DI exceeds 80, discomfort is felt by everyone.

Where the discomfort index is denoted by DI, the temperature of space 4 is denoted by Tdi, and the humidity of space 4 is denoted by H, controller 32 controls floor heating device 8 to cause temperature Tf of floor 20 to be less than or equal to the temperature Tdi that satisfies Equation 2 below (i.e., the discomfort index is less than or equal to 80), and cause temperature Tf of floor 20 to be greater than or equal to the temperature Tn that satisfies Equation 1 above.

$$DI = 0.81 Tdi + 0.01 H \times ( 0.99 Tdi - 14.3 ) + 46.3 \qquad ( Equation 2 )$$

However, in Equation 2 above, discomfort index DI=80 and humidity H=100%. For a performance in space 4, since it is necessary to set a relatively high humidity H of space 4 to make the mist sprayed in space 4 visible, humidity H=100% is set.

As described above, in this variation of the present embodiment, control device 10 further controls the temperature of floor 20 to cause the temperature of floor 20 to be greater than or equal to temperature Tn, and cause the discomfort index, which is calculated based on the temperature and the humidity of space 4, to be less than or equal to 80.

Furthermore, in the present embodiment, where the discomfort index is DI, the temperature of space 4 is Tdi, and the humidity of space 4 is H, control device 10 controls the temperature of floor 20 to cause the temperature of floor 20 to be less than or equal to the temperature Tdi that satisfies Equation 2 above.

Accordingly, it is possible to prevent a case where everyone present in space 4 feels discomfort even when humidity H of space 4 is set relatively high (e.g., humidity H=100%) to make the mist sprayed in space 4 visible for the performance in space 4, for example.

### Other Variations, Etc.

As described above, the foregoing embodiments were presented as examples of the techniques disclosed in the present application. However, the techniques in the present disclosure are not limited to these examples, and the techniques are also applicable to embodiments arrived at by making modifications, substitutions, additions, omissions, etc., as necessary. Moreover, new embodiments may also be obtained by combining the various elements described in the above-mentioned embodiments.

Next, other embodiments will be described.

In the foregoing embodiments, although controller 32 of control device 10 controls floor heating device 8 to cause temperature Tf of floor 20 to be greater than or equal to the temperature Tn that satisfies Equation 1 above, control may be performed as described below, for example. More specifically, controller 32 may control floor heating device 8 to cause temperature Tf of floor 20 to be greater than or equal to the temperature Tn that satisfies Equation 1 above, and cause the temperature of floor 20 to be less than or equal to 29° C. With regard to floor heating device 8, it is typically known that when the temperature of floor 20 is less than or equal to 29° C., people present in space 4 feel comfortable. For this reason, by controlling floor heating device 8 as described above, floor 20 can be prevented from becoming wet due to mist, and the people present in space 4 can be provided with a comfortable environment. In this case, in order to prevent floor 20 from becoming wet due to mist, the amount of mist, and the like, sprayed from misting device 6 may be appropriately controlled.

Moreover, in the foregoing embodiments, each element may be configured as dedicated hardware, or may be realized by executing a software program suitable for the respective element. Alternatively, elements may be implemented by a program executer, such as a CPU or a processor, reading and executing a software program recorded on a non-transitory recording medium, such as a hard disk or semiconductor memory.

Furthermore, some or all of the functions of control device 10 according to the foregoing embodiments may be implemented by a processor, such as a CPU, executing a program.

As presented above, the embodiments have been described to exemplify the techniques of the present disclosure. To this extent, the accompanying drawings and detailed descriptions have been provided.

Consequently, the elements described in the accompanying drawings and detailed descriptions include not only those elements essential to solving the problem, but they may also include elements which, while not being essential to solving the problem, have been included in order to exemplify the above-mentioned techniques. For this reason, such non-essential elements should not readily be deemed to be essential based on the mere fact that they are described in the accompanying drawings and detailed descriptions.

Moreover, the above-mentioned embodiments are used to exemplify techniques described in the present disclosure. Thus, various modifications, substitutions, additions, omissions, or the like can be made within the scope of the claims and the equivalents thereof.

### APPENDIX

The description of the foregoing embodiments discloses the following techniques.

A misting system according to a first aspect of the present disclosure includes: a misting device that sprays mist in a space; and a control device that controls a temperature of a floor of the space. The control device controls the temperature of the floor to cause the temperature of the floor to be greater than or equal to a temperature Tn that satisfies Equation 1 above, where an amount of the mist sprayed in the space by the misting device is denoted by M, an amount of water vapor in the space is denoted by N, and a temperature calculated based on a temperature of the space is denoted by Tn.

Furthermore, in the misting system according to a second aspect of the present disclosure, in the first aspect, the control device further controls the temperature of the floor to cause the temperature of the floor to be greater than or equal to the temperature Tn, and cause a discomfort index to be less than or equal to 80, the discomfort index being calculated based on the temperature of the space and a humidity of the space.

Furthermore, in the misting system according to a third aspect of the present disclosure, in the second aspect, the control device controls the temperature of the floor to cause the temperature of the floor to be less than or equal to a temperature Tdi that satisfies Equation 2 above, where the discomfort index is denoted by DI, the temperature of the space is denoted by Tdi, and the humidity of the space is denoted by H. However, in Equation 2 above, the discomfort index DI is 80 and the humidity H is 100 percent.

Furthermore, in the misting system according to a fourth aspect of the present disclosure, in any one of the first aspect to the third aspect, a particle diameter of the mist sprayed in the space by the misting device is less than or equal to 10 μm.

Furthermore, in the misting system according to a fifth aspect of the present disclosure, in any one of the first aspect to the fourth aspect, the floor is made of one of plywood, natural wood, synthetic resin, or concrete.

Furthermore, a control method according to a sixth aspect of the present disclosure is a control method for use in a misting system for spraying mist in a space, and the control method includes: (a) spraying the mist in the space; and (b) controlling a temperature of a floor of the space. In (b), the temperature of the floor is controlled to cause the temperature of the floor to be greater than or equal to a temperature Tn that satisfies Equation 1 above, where an amount of the mist sprayed in the space in (a) is denoted by M, an amount of water vapor in the space is denoted by N, and a temperature calculated based on a temperature of the space is denoted by Tn.

### INDUSTRIAL APPLICABILITY

The present disclosure is applicable as a misting system, or the like, that sprays mist in a space for a performance in a space, for example.

### REFERENCE SIGNS LIST

2 misting system
4 space
6 misting device
8 floor heating device
10 control device
11 compressed air supply
12 compressed air channel
13 liquid supply
14 liquid channel
16 nozzle
18 ceiling
20 floor
22 mist amount sensor
24 temperature sensor
26 humidity sensor
28 obtainer
30 calculator
32 controller

1. A misting system comprising:
a misting device that sprays mist in a space; and
a control device that controls a temperature of a floor of the space, wherein
the control device controls the temperature of the floor to cause the temperature of the floor to be greater than or equal to a temperature Tn that satisfies Equation 1 below:
$$\begin{matrix}[ Math . 1 ] & \\ M + N = \frac{217 \times 6.1078 \times {10}^{\frac{7.5 \times Tn}{Tn + 237.3}}}{Tn + 273.15} & ( Equation 1 )\end{matrix}$$
where an amount of the mist sprayed in the space by the misting device is denoted by M, an amount of water vapor in the space is denoted by N, and a temperature calculated based on a temperature of the space is denoted by Tn.

2. The misting system according to claim 1, wherein
the control device further controls the temperature of the floor to cause the temperature of the floor to be greater than or equal to the temperature Tn, and cause a discomfort index to be less than or equal to 80, the discomfort index being calculated based on the temperature of the space and a humidity of the space.

3. The misting system according to claim 2, wherein
the control device controls the temperature of the floor to cause the temperature of the floor to be less than or equal to a temperature Tdi that satisfies Equation 2 below:
DI=0.81Tdi+0.01H×(0.99Tdi−14.3)+46.3 (Equation 2)
where the discomfort index is denoted by DI, the temperature of the space is denoted by Tdi, and the humidity of the space is denoted by H, wherein
in Equation 2 above, the discomfort index DI is 80 and the humidity H is 100 percent.

4. The misting system according to claim 1, wherein
a particle diameter of the mist sprayed in the space by the misting device is less than or equal to 10 μm.

5. The misting system according to claim 1, wherein
the floor is made of one of plywood, natural wood, synthetic resin, or concrete.

6. A control method for use in a misting system for spraying mist in a space, the control method comprising:
(a) spraying the mist in the space; and
(b) controlling a temperature of a floor of the space, wherein
in (b), the temperature of the floor is controlled to cause the temperature of the floor to be greater than or equal to a temperature Tn that satisfies Equation 1 below:
$$\begin{matrix}[ Math . 1 ] & \\ M + N = \frac{217 \times 6.1078 \times {10}^{\frac{7.5 \times Tn}{Tn + 237.3}}}{Tn + 273.15} & ( Equation 1 )\end{matrix}$$
where an amount of the mist sprayed in the space in (a) is denoted by M, an amount of water vapor in the space is denoted by N, and a temperature calculated based on a temperature of the space is denoted by Tn.
